(19) United States
(12) Patent Application Publication
(10) Pub. No.: US 2010/0258371 A1
(43) Pub. Date: Oct. 14, 2010

(54) WATERBORNE FILM-FORMING COMPOSITIONS HAVING HEAT REFLECTIVE PROPERTIES

(76) Inventor: Umesh C. Desai, Wexford, PA (US)

Correspondence Address: PPG INDUSTRIES INC;INTELLECTUAL PROPERTY DEPT, ONE PPG PLACE, PITTSBURGH, PA, 15272, US

(21) Appl. No.: 12/824,679

(22) Filed: Jun. 28, 2010

Related U.S. Application Data
(63) Continuation-in-part of application No. 12/165,835, filed on Jul. 1, 2008.

(51) Int. Cl. B60K 13/04; B32B 27/38

(52) U.S. Cl. 180/89.2; 428/413; 428/212

(57) ABSTRACT

A heat reflective system in which a curable composition is deposited and cured onto a substrate, wherein the curable composition comprises: (a) a resinous binder comprising a polyamideimide, a polyepoxide and/or a polysiloxane; and (b) a metallic reflective pigment. After application to a surface of a substrate and after curing, when the coated surface is exposed to a heat source having a temperature up to 390° C. at a distance of at least ½ inch (1.27 cm), the reverse side of the substrate is at least 20 Celsius degrees lower than the temperature of the reverse side of a similar substrate without the curable film-forming composition.

### CROSS-REFERENCE TO RELATED APPLICATIONS

This application is a continuation-in-part of U.S. application Ser. No. 12/165,835, filed Jul. 1, 2008, which is herein incorporated by reference.

### FIELD OF THE INVENTION

The present invention relates to film-forming compositions demonstrating heat reflection properties and to heat reflective systems that include substrates coated with film-forming compositions demonstrating heat reflection properties.

### BACKGROUND OF THE INVENTION

Metal substrates used in industrial applications and as parts in vehicular or other engine and exhaust systems are routinely subjected to extreme high temperatures, which over time may lead to fatigue, cracking, distortion, and other failures of the substrate. For example, components near an automotive exhaust system can be exposed to temperatures in excess of 400° C. In such a situation, it is readily apparent that fatiguing or cracking can lead to catastrophic failure. Insulating an automotive floor pan is especially challenging when the distance between the exhaust system and the floor is reduced, as in more compact cars. Conventionally, the automotive industry inserts aluminum sheet between the exhaust system and the floor-pan to deflect and insulate, with air gap or pads between the aluminum sheet and floor-pan. This method has high manual labor costs and requires extra spacing between the exhaust system and the floor-pan.

It would be desirable to provide heat reflective, curable film-forming compositions that can minimize the conduction of heat through a substrate to which it is applied, particularly when exposed to extreme high temperatures, eliminating the need for manually inserted sheets and pads and thereby saving space between the exhaust system and the floor-pan.

### SUMMARY OF THE INVENTION

The present invention is directed to heat reflection system comprising:
(a) a heat source;
(b) a substrate positioned adjacent the heat source and having a first side and a second side, the first side positioned between the heat source and the second side; and
(c) a cured coating layer on the first side of the substrate, wherein the cured coating layer is formed from a curable coating composition, wherein the curable coating composition comprises a resinous binder comprising a polyepoxide, a polyamideimide, a polyimide, and/or a polysiloxane; and a metallic reflective pigment.

In certain embodiments, after application to a surface of a steel substrate and after curing, when the coated surface is exposed to a heat source having a temperature up to 390° C. at a distance of at least ½ inch (1.27 cm), the reverse side of the substrate is at least 20 Celsius degrees lower than the temperature of the reverse side of a similar substrate without the curable film-forming composition. In certain embodiments, when the coated surface is exposed to a heat source having a temperature up to 390° C. at a distance of ½ inch (1.27 cm), the reverse side of the substrate is at least 250 Celsius degrees lower than the temperature of the heat source. In addition, when the coated surface is exposed to a heat source having a temperature up to 390° C. at a distance of 1 inch (2.54 cm), the reverse side of the substrate is at least 295 Celsius degrees lower than the temperature of the heat source.

In certain embodiments, the heat source is the exhaust system of a motor vehicle, and the substrate is a floor pan that is positioned such that coated side of the floor pan is adjacent to the heat source.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The term “reactive” refers to a functional group capable of undergoing a chemical reaction with itself and/or other functional groups spontaneously or upon the application of heat or in the presence of a catalyst or by any other means known to those skilled in the art.

The exemplary embodiments of the present invention may be directed to a heat reflection system in which a curable composition is deposited and cured to a first side of a substrate and a second side of the substrate is left uncoated. The substrate is then positioned near a heat source such that the coated first side is adjacent the heat source. The coated surface acts to reflect a substantial portion of the heat away from the second uncoated side of the substrate.

In one exemplary embodiment, the substrate is a metal floor pan for a motor vehicle, and the heat source is the motor vehicle's exhaust system, which may have temperatures in excess of 400° C. By positioning the floor pan such that the coated first side is adjacent the exhaust system (i.e. the coated first side of the floor pan is located between the exhaust system and the uncoated second side), a substantial portion of the heat created by the exhaust system may be deflected away from the second uncoated side of the floor pan. This is turn may protect portions of the motor vehicle located nearer to the second uncoated side (i.e. the second uncoated side is located between the first coated side and the portions of the motor vehicle), such as the passenger compartment of the motor vehicle and associated parts in a motor vehicle that may be damaged by prolonged exposure to high temperatures. The reflective nature of the cured coating material prevents damage to the underlying floor pan substrate and components of the motor vehicle in the form of fatigue, cracking, distortion or other failures associated with high temperature exposure.

The curable compositions of the present invention comprise a resinous binder (a) which may be a polyepoxide, a polyamideimide, a polyimide, and/or a polysiloxane. Mixtures of resinous binders, such as a combination of polysiloxane and polyepoxide, may be used.

Epoxy-functional polymers each typically have at least two epoxide or oxirane groups per molecule. As used herein, “epoxy-functional polymers” means epoxy-functional oligomers, polymers and/or copolymers. These materials often are referred to as di- or polyepoxides. Generally, the epoxide equivalent weight of the epoxy-functional polymer can range from about 70 to about 4,000, and usually about 140 to about 600, as measured by titration with perchloric acid and quaternary ammonium bromide using methyl violet as an indicator.

Suitable epoxy-functional polymers can be saturated or unsaturated, cyclic or acyclic, aliphatic, alicyclic, aromatic or heterocyclic. The epoxy-functional polymers can have pendant or terminal hydroxyl groups, if desired. They can contain substituents such as halogen, hydroxyl, and ether groups. A useful class of these materials includes polyepoxides comprising epoxy polyethers obtained by reacting an epihalohydrin (such as epichlorohydrin or epibromohydrin) with a di- or polyhydric alcohol in the presence of an alkali. Suitable polyhydric alcohols include polyphenols such as resorcinol; catechol; hydroquinone; bis(4-hydroxyphenyl)-2,2-propane, i.e., bisphenol A; bis(4-hydroxyphenyl)-1,1-isobutane; 4,4-dihydroxybenzophenone; bis(4-hydroxyphenol)-1,1-ethane; bis(2-hydroxyphenyl)-methane and 1,5-hydroxynaphthalene.

Frequently used polyepoxides include polyglycidyl ethers of Bisphenol A, such as EPON® 828 and 1001 epoxy resins, which are commercially available from Hexion Specialty Chemicals, Inc. EPON® 828 epoxy resin has a number average molecular weight of about 400 and an epoxy equivalent weight of about 185-192. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, epoxy novolac resins, and polyepoxides that are partially defunctionalized by carboxylic acids, alcohol, water, phenols, mercaptans or other active hydrogen-containing compounds to give hydroxyl-containing polymers. These polyepoxides are well known to those skilled in the art and are described in U.S. Pat. No. 4,739,019 at column 2, line 6 through column 3, line 12. In particular embodiments, waterborne polyepoxides such as EPI-REZ 6520, a dispersion of Epon 1001, also available from Hexion Specialty Chemicals, is especially suitable.

Suitable polyamideimides include Vylomax HR-11NN available from TOYOBO COMPANY.

Suitable polyimides include U-Varnish available from UBE Industries, Ltd. Film formation is accomplished by condensation reaction during heat curing.

Suitable polysiloxanes include any of those known for use in coating compositions. For example, the polysiloxane may comprise at least one of the following structural units (I):

R¹ₙR²ₘSiO_{(4-n-m)/2} (I)

wherein each R¹, which may be identical or different, represents H, OH, a monovalent hydrocarbon group, and a monovalent siloxane group; each R², which may be identical or different, represents a group comprising at least one reactive functional group. Each of m and n depicted in the structural unit (I) above fulfills the requirements of 0<n<4, 0<m<4 and 2≦(m+n)<4. When (m+n) is 3, the value represented by n can be 2 and the value represented by m is 1. Likewise, when (m+n) is 2, the value represented by each of n and m is 1.

The polysiloxane may alternatively have the following structure (II) or (III):

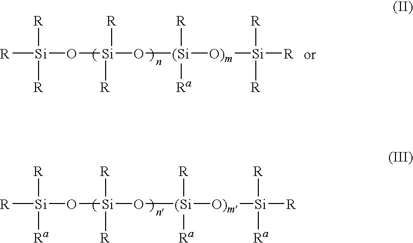

wherein m has a value of at least 1; m′ ranges from 0 to 75; n ranges from 0 to 75; n′ ranges from 0 to 75; each R, which may be identical or different, is selected from H, OH, a monovalent hydrocarbon group, a monovalent siloxane group, and mixtures of any of the foregoing; and —R^{a} comprises the following structure (IV):

—R³—X (IV)

wherein —R³ is selected from an alkylene group, an oxyalkylene group, an alkylene aryl group, an alkenylene group, an oxyalkenylene group, and an alkenylene aryl group; and X represents a group which comprises at least one reactive functional group selected from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group such as an acrylate group and a methacrylate group, a maleimide group, a fumarate group, an onium salt group such as a sulfonium group and an ammonium group, an anhydride group, a hydroxy alkylamide group, and an epoxy group.

Formulae (II) and (III) are diagrammatic, and are not intended to imply that the parenthetical portions are necessarily blocks, although blocks may be used where desired. In some cases the polysiloxane may comprise a variety of siloxane units. This is increasingly true as the number of siloxane units employed increases, and especially true when mixtures of a number of different siloxane units are used. In those instances where a plurality of siloxane units are used and it is desired to form blocks, oligomers can be formed which can be joined to form the block compound. By judicious choice of reactants, compounds having an alternating structure or blocks of alternating structure may be used.

Particularly suitable polysiloxanes include methylphenyl polysiloxane and others sold under the name SILRES, available from Wacker Chemie AG.

The amount of the resinous binder (a) in the curable film-forming composition can vary depending in part upon the intended application of the composition. In a typical embodiment, the resinous binder (a) is present in an amount ranging from 5 to 85 weight percent based on the total weight of the composition.

Typically, the resinous binder is present as a liquid or dispersion, although combinations of liquid and solid resins can be used as long as the desired viscosity of the curable composition is obtained from the other components of the composition.

If necessary, the curable composition of the present invention may further comprise one or more contemporaneous and/or latent curing agents, depending on the nature of the resinous binder (a). Curing agents have functional groups reactive with functional groups in the resinous binder (a). Useful curing agents include: dicyandiamide; polyurea; aliphatic, cycloaliphatic, and aromatic polyfunctional amines such as ethylene diamine, diethylene triamine, triethylene tetraamine, tetraethylene pentamine, 1,4-diaminobutane; 1,3-diaminobutane, hexamethylene diamine, 3-(N-isopropylamino)propylamine, diaminocyclohexane, and polyoxypropylene amines commercially available under the trademark designation JEFFAMINE®; meta-phenylene diamine; p,p′-methylene dianiline, and 1,4-aminonaphthalene; polyamides such as those derived from fatty acids, dimerized fatty acids or polymeric fatty acids and aliphatic polyamines, for example, the materials commercially available from Henckel under the trademark designations VERSAMIDE 220 or 125. Adducts of dicyandiamide and 2-methylimidazole are also suitable. Latent cure systems may also comprise substituted urea accelerators such as phenyl dimethyl urea, toluene dimethyl urea, cycloaliphatic bisurea available as OMICURE from CVC Specialty Chemicals. Polyamine curing agents available under the names EPI-CURE from Hexion Specialty Chemicals are used often in the compositions of the present invention.

Combinations of curing agents may be suitable; in a particular embodiment of the present invention, the resinous binder (a) comprises an aqueous polyepoxide and the curing agent (b) is present and comprises dicyandiamide and a polyurea functional reaction product of diethylene glycol adipate, isophorone diisocyanate, and dimethylamine.

When used, the curing agent (b) is present in the curable compositions of the present invention in an amount ranging from 0.5 to 50 percent by weight, based on the total weight of the composition.

The curable film-forming compositions of the present invention further comprise a metallic reflective pigment. Suitable metallic pigments include aluminum such as aluminum flake, copper or bronze flake and metal oxide coated mica. Silica encapsulated aluminum pigment is particularly suitable in certain embodiments of the present invention. The metallic reflective pigment is used in an amount ranging from 5 to 30 percent, often 12 to 24 percent by weight based on the total weight of the composition.

In certain embodiments of the present invention, the composition is essentially free of titanium dioxide. By “essentially free” is meant that if the material is present in the composition, it is present incidentally in an amount less than five percent by weight, usually less than trace amounts.

The curable film-forming compositions of the present invention may additionally contain adjuvant resins. Acrylic polymers are most often used as adjuvant resins. The acrylic polymers may be prepared from any known ethylenically unsaturated monomers having acrylic or methacrylic functionality, and may be additionally prepared with non-acrylic ethylenically unsaturated monomers using techniques known in the art. Particularly suitable acrylic polymers useful as adjuvant resins in the curable film-forming composition of the present invention contain reactive functional groups such as active hydrogen groups. Examples include Acrylic latex P8182, available from PPG Industries, Inc.

The curable compositions of the present invention can include a variety of optional ingredients and/or additives that are somewhat dependent on the particular application of the curable composition, such as pigments, reinforcements, thixotropes, accelerators, surfactants, plasticizers, extenders, stabilizers, corrosion inhibitors, diluents, and antioxidants. Suitable thixotropes include organic thickeners, bentonite, and fatty acid/oil derivatives. Rheology additives that further aid in pigment orientation, such as DISPARLON, a polyamide wax available from King Industries, are used often in the composition of the present invention. Thixotropes are generally present in an amount of up to about 7 weight percent.

Diluents and plasticizers can be present in an amount of up to about 50 weight percent of the total weight of the curable composition. Examples of suitable diluents include low molecular weight (from about 100 to about 2000) aliphatic or aromatic ester compounds containing one or more ester linkages, and low molecular weight aliphatic or aromatic ethers containing one or more ether linkages and combinations thereof. Reactive diluents are designed to modify strength and/or adhesion of the cured composition, such as aliphatic and/or aromatic mono, di, or tri epoxides having a weight average molecular weight of about 300 to about 1500, can be present in the range of up to about 30 weight percent of the total weight of the curable composition (preferably 5 to 10 percent).

The compositions of the present invention are typically liquid and may be solventborne or waterborne. By “liquid” is meant that the compositions have a viscosity that allows them to be at least extrudable. The compositions may have a viscosity that allows them to be at least pumpable, and often the compositions have a viscosity that allows them to be at least sprayable. Often the composition can be continuously agitated before spraying for homogeneous pigment dispersion.

Liquid compositions that are suitable for use in the present invention include liquid resin systems that are 100 percent resin solids, liquid resins that are dissolved or dispersed in a liquid medium, and solid particulate resins that are dispersed in a liquid medium. Liquid media may be aqueous based or organic solvent based.

The curable compositions of the present invention can be prepared in a number of ways, including as a one-package composition with a latent curing agent or as a two-package composition, typically curable at ambient temperature. Two-package curable compositions are typically prepared by combining the ingredients mixing the two parts immediately before use. A one-package composition can be prepared in advance of use and stored. An exemplary one-package composition contains polyurea and dicyandiamide as the curing agent (b). Polyamine and/or epoxy-amine curing agents are typically used in two-package systems.

The preparation of the curable composition can be in a manner similar to that of U.S. Pat. No. 4,739,019, at column 6, lines 2-62, using mixing equipment known to those skilled in the art such as triaxial, Cowel, Nauta and Hockmeyer mixers.

Substrates to which compositions of the present invention may be applied include rigid metal substrates such as titanium, ferrous metals, aluminum, aluminum alloys, copper, and other metal and alloy substrates. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

When the composition is used in automotive applications, the thickness of the automotive substrate typically ranges from 0.254 to 3.18 millimeters (mm) (10 to 125 mils), typically 0.6 to 1.2 mm (23.6 to 47.2 mils) although the thickness can be greater or less, as desired. The width of a coil strip generally ranges from 30.5 to 183 centimeters (12 to 72 inches), although the width of the substrate can vary depending upon its shape and intended use.

Before depositing any treatment or coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The substrate to which the composition of the present invention is applied may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, and the like.

The composition may be applied to the substrate by one or more of a number of methods including spraying, extruding, brushing, or by hand with a blade. The composition has a viscosity that allows it to be at least extrudable. The composition is most often applied by electrostatic spraying.

The compositions can be cured by allowing them to stand at ambient temperature, or a combination of ambient temperature cure and baking, or by baking alone, depending on the cure chemistry. The compositions can be cured at ambient temperature typically in a period ranging from about 24 hour to about 36 hours. If ambient temperature and baking are utilized in combination, the composition is typically allowed to stand for a period up to 24 hours followed by baking at a temperature of from about 75° C. to about 200° C., often from about 150° C. to about 180° C., for a period of time ranging from about 20 minutes to about 1 hour.

After application of the composition of the present invention to a surface of a substrate and after curing, when the coated surface is exposed to a heat source having a temperature up to 390° C. at a distance of at least ½ inch (1.27 cm), the reverse side of the substrate is at least 20 Celsius degrees lower than the temperature of the reverse side of a similar substrate without the curable film-forming composition (i.e., an uncoated substrate). In particular, after application to a surface of a steel substrate and after curing, when the coated surface is exposed to a heat source having a temperature up to 390° C. at a distance of ½ inch (1.27 cm), the reverse side of the substrate is at least 250 Celsius degrees lower than the temperature of the heat source.

In certain embodiments of the present invention, after application of the composition of the present invention to a steel substrate and after curing, when the coated surface is exposed to a heat source having a temperature up to 390° C. at a distance of 1 inch (2.54 cm), the reverse side of the substrate is at least 295 Celsius degrees lower than the temperature of the heat source.

The following examples are intended to illustrate various embodiments of the invention, and should not be construed as limiting the invention in any way.

### EXAMPLES

Examples 1 to 9 demonstrate coating compositions prepared in accordance with the present invention.

| | Examples | | | | | | | | |
|---|---|---|---|---|---|---|---|---|---|
| | 1 | 2 | 3 | 4 | 5 | 6 | 7 | 8 | 9 |
| RAW MATERIAL | 1 | 2 | 3 | 4 | 5 | 6 | 7 | 8 | 9 |
| | | | | Part A | Part A | | | | |
| EPI-REZ 6520¹ | 50.0 | 50.0 | 50.0 | 15.0 | | | | | |
| Acrylic latex P8182² | 12.5 | | | | | | | | |
| Silkopone EW³ | | | | | | 50.0 | | | |
| Silkopone EF⁴ | | | | | 25.0 | | | | |
| Silres MP42E⁵ | | 12.5 | | | | | 50.0 | | |
| Vylomax HR-11NN⁶ | | | | | | | | 32.0 | |
| U-varnish A⁷ | | | | | | | | | 32.00 |
| Polyurea P8183⁸ | 0.90 | 0.90 | 0.90 | | | 0.88 | | | |
| Dicy⁹ | 1.3 | 1.3 | 1.3 | | | 1.3 | | | |
| STAP IL HYDROLAN 2153¹⁰ | 25.0 | 25.0 | 21.0 | 9.7 | 11.0 | 21.0 | 21.0 | | |
| Toyo ALPASTE TCR 6130¹¹ | | | | | | | | 12.0 | 12.0 |
| Downol PM¹² | 6.25 | 6.25 | 6.25 | 3.00 | 2.00 | 3.00 | 6.25 | | |
| M-Pyrol¹³ | | | | | | | | 12.0 | 12.0 |
| Downol DPnB¹⁴ | 6.25 | 6.25 | 6.25 | 2 | 2 | 3 | 6.25 | | |
| | | | | Part B | Part B | | | | |
| KBE 903 silane¹⁵ | | | | | 6.3 | | | | |
| EPIKURE 6870-W-53¹⁶ | | | | 9.0 | | | | | |
| TOTAL WEIGHT | 102.200 | 102.200 | 85.700 | 38.700 | 46.250 | 79.125 | 83.500 | 56.000 | 56.000 |
| SOLIDS | 47.2% | 48.6% | 48.9% | 49.2% | 81.9% | 52.9% | 40.9% | 24.3% | 26.2% |

¹Waterborne dispersion of solid Bisphenol A epoxy resin from Hexion Specialty Chemicals
²Acrylic Latex available from PPG Industries, Adrian, Michigan
³Solvent borne silicone epoxide from Evonik Industries
⁴Solvent-free silicone epoxy from Evonik Industries
⁵Aqueous methylphenyl silicone resin emulsion from Wacker Chemical Corporation
⁶Polyamideimide from Toyobo Company
⁷Polyimide Varnish from UBE Industries, Ltd.
⁸Polyurea available from PPG Industries, Adrian, Michigan
⁹Dicyandiamide available from ALZ CHEM
¹⁰Silica encapsulated Aluminum flakes from Eckart America Corporation
¹¹Aluminum pigment paste from TOYO ALUMINUM K.K.
¹²PROPYLENE GLYCOL MONOMETHYL ETHER from Dow Chemical Co.
¹³N-METHYL-2-PYRROLIDONE from INTERNATIONAL SPECIALTY PRODUCTS
¹⁴DIPROPYLENE GLYCOL N-BUTYL ETHER from Dow Chemical Co.
¹⁵3-AMINOPROPYLTRIETHOXYSILANE from SHIN-ETSU SILICONENS OF AMERICA
¹⁶Modified epoxyamine adduct from Hexion Specialty Chemicals

Mixing for Part A and first component was done in Speedmixer DC 600FVZ. Mix ingredients 1 to 8 at 2350 RPM for 60 seconds. Add 9 and mix 60 seconds. Then add 10 to 14 followed by 60 second mix at 2350 RPM. Freshly agitated mix was used to make a draw down on 4″×12″ panels. Part B or second component for 2K system was mixed with Part A for 60 seconds in at 2350 RPM prior to draw down. 5 to 7 mils wet thickness was applied on the panel.

The coating compositions of each example were applied to ACT 40237 CRS,B952 P60DIW, ED6060, 0.032 mil substrates and flashed for 30 minutes at room temperature, followed by two 30-minute bakes at 200° F.+30 minutes at 350° F.

Coated side of the panel was placed ½ inch and 1 inch above VWR Hot plate VHP-C4 surface. Hot plate was set at 390° C.; however, effective temperature on the hot plate surface was between 390° C. and 450° C. depending on the distance or type of reflective coating on the panel being tested. Thermocouple was not placed on the hot plate surface during testing to avoid interference in radiated heat. A TC405-6 SURFACE PROBE from Fisher Scientific was placed on the backside (uncoated) of the panel and was connected to Omega DP470 Digital Indicator, Scanner and Datalogger as well as a computer to store 30 minutes of continuous readings. Average of 30 minutes of data are reported in the Table:

| | Coating | Hot Plate | Panel back temp. ° C. | | Reduced from Bare ° C. | | Reduced from source ° C. | |
|---|---|---|---|---|---|---|---|---|
| Sample | mils | set @ ° C. | 0.5″ away | 1″ away | 0.5″ away | 1″ away | 0.5″ away | 1″ away |
| Bare ED | — | 390 | 156.2 | 111.1 | — | — | 233.8 | 278.9 |
| Example 1 | 2.5 | 390 | 104.6 | 76.3 | 51.6 | 34.8 | 285.4 | 313.7 |
| Example 2 | 2 | 390 | 103.1 | 73.4 | 53.1 | 37.7 | 286.9 | 316.6 |
| Example 3 | 1-2 | 390 | 103.8 | 75.8 | 52.4 | 35.3 | 286.2 | 314.2 |
| Example 4 air dry | 2 | 390 | 115.3 | 85.1 | 40.9 | 26 | 274.7 | 304.9 |
| Example 5 air dry | 3.5 | 390 | 121.3 | 88.2 | 34.9 | 22.9 | 268.7 | 301.8 |
| Example 6 | 2 | 390 | 115.4 | 78.6 | 40.8 | 32.5 | 274.6 | 311.4 |
| Example 7 | 1 | 390 | 94 | 65.9 | 62.2 | 45.2 | 296 | 324.1 |
| Example 8 | 1 | 390 | 86.1 | 62.7 | 70.1 | 48.4 | 303.9 | 327.3 |
| Example 9 | 1 | 390 | 98.2 | 66 | 58 | 45.1 | 291.8 | 324 |

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A heat reflection system comprising:
(a) a heat source;
(b) a substrate positioned adjacent the heat source and having a first side and a second side, the first side positioned between the heat source and the second side; and
(c) a cured coating layer on the first side of the substrate, wherein the cured coating layer is formed from a curable coating composition, wherein the curable coating composition comprises:
a resinous binder comprising a polyepoxide, a polyamideimide, a polyimide, and/or a polysiloxane; and
a metallic reflective pigment.

2. The heat reflection system of claim 1, wherein the resinous binder comprises methylphenyl polysiloxane.

3. The heat reflection system of claim 1, wherein the curable coating composition further comprises a curing agent that is reactive with the resinous binder.

4. The heat reflection system of claim 3, wherein the curing agent comprises dicyandiamide, a polyurea, an aliphatic polyfunctional amine, a cycloaliphatic polyfunctional amine, an aromatic polyfunctional amine, a polyamide, and/or an adduct of dicyandiamide and 2-methylimidazole.

5. The heat reflection system of claim 3, wherein the resinous binder comprises an aqueous polyepoxide and the curing agent comprises dicyandiamide and a polyurea functional reaction product of diethylene glycol adipate, isophorone diisocyanate, and dimethylamine.

6. The heat reflection system of claim 1, wherein the metallic reflective pigment comprises silica encapsulated aluminum pigment.

7. The heat reflection system of claim 1, wherein the curable coating composition further comprises an adjuvant resin.

8. The heat reflection system of claim 7, wherein the adjuvant resin comprises an acrylic polymer.

9. The heat reflection system of claim 1, wherein the resinous binder is present in an amount ranging from 5 to 85 weight percent based on the total weight of the curable coating composition.

10. The heat reflection system of claim 1, wherein the curing agent is present in an amount ranging from 0.5 to 50 weight percent based on the total weight of the curable coating composition.

11. The heat reflection system of claim 1, wherein the metallic reflective pigment comprises an amount ranging from 5 to 30 weight percent based on the total weight of the curable coating composition

12. The heat reflection system of claim 11, wherein the metallic reflective pigment comprises an aluminum flake pigment.

13. The heat reflection system of claim 1, wherein the resinous binder comprises an aqueous polyepoxide and/or an aqueous polysiloxane.

14. The heat reflection system of claim 1, wherein the temperature of the second side of the substrate is at least 250 degrees Celsius lower than the temperature of the heat source when the heat source is positioned 1.27 cm from the first side of the substrate, wherein the temperature of the heat source is 390 degrees Celsius.

15. The heat reflection system of claim 1, wherein the temperature of the second side of the substrate is at least 295 degrees Celsius lower than the temperature of the heat source when the heat source is positioned 2.54 cm from the first side of the substrate, wherein the temperature of the heat source is 390 degrees Celsius.

16. The heat reflection system of claim 1, wherein the temperature of the second side of the substrate at least 20 degrees Celsius lower than the temperature of a second side of a similar substrate without the cured coating layer when the heat source is positioned 1.27 cm from the first side of the substrate and wherein the temperature of the heat source is 390 degrees Celsius.

17. A heat reflection system for a motor vehicle comprising:
(a) an exhaust system;
(b) a floor pan positioned adjacent the exhaust system and having a first side and a second side, the first side positioned between the exhaust system and the second side; and
(c) a curable film forming coating composition applied to and cured upon the first side of the floor pan to form a cured coating layer on the first side of the floor pan, wherein the curable film forming coating composition comprises:
a resinous binder comprising a polyepoxide, a polyamideimide, a polyimide, and/or a polysiloxane; and
a metallic reflective pigment in an amount ranging from 5 to 30 weight percent based on the total weight of the curable film forming composition;

18. The heat reflection system of claim 17, wherein the temperature of the second side of the floor pan is at least 250 degrees Celsius lower than the temperature of the exhaust system when the exhaust system is positioned 1.27 cm from the first side of the substrate, wherein the temperature of the heat source is 390 degrees Celsius.

19. The heat reflection system of claim 17, wherein the temperature of the second side of the floor pan is at least 295 degrees Celsius lower than the temperature of the exhaust system when the exhaust system is positioned 2.54 cm from the first side of the substrate, wherein the temperature of the heat source is 390 degrees Celsius.

20. The heat reflection system of claim 17, wherein the temperature of the second side of the floor pan is at least 20 degrees Celsius lower than the temperature of a second side of a similar floor pan without the cured coating layer when the exhaust system is positioned 1.27 cm from the first side of the flooring panel and wherein the temperature of the exhaust system is 390 degrees Celsius.
